(19) United States
(12) Patent Application Publication
(10) Pub. No.: US 2022/0243497 A1
(43) Pub. Date: Aug. 4, 2022

(54) ELECTRONIC LOCK WITH ADJUSTABLE DEAD LATCH CHANNEL LOCATION

(71) Applicant: YI-FAN LIAO, TAOYUAN CITY (TW)

(72) Inventor: YI-FAN LIAO, TAOYUAN CITY (TW)

(21) Appl. No.: 17/643,633

(22) Filed: Dec. 10, 2021

(30) Foreign Application Priority Data
Feb. 2, 2021 (TW) 110201288

(51) Int. Cl. E05B 15/02; E05B 47/00

(52) U.S. Cl. CPC E05B 15/0245; E05B 2015/0275; E05B 47/0046

(57) ABSTRACT

An electronic lock with adjustable dead latch channel location, comprising: an electronic lock body, having a housing cavity and a latch bolt; a plate, further having a gap for exposing the housing cavity and the latch bolt; a fixed adjust element, the middle section of the fixed adjust element is arranged below the gap, and set a fixed channel and a fixed positioning unit; and an active adjust element, the ramp element having an active channel relative to the positioning channel, and having an active positioning unit, so the present invention does not need to disassemble the entire electronic lock from the door frame, and can directly adjust the position of the dead latch channel.

### BACKGROUND OF THE INVENTION

### 1. Field of the Invention

The invention relates to an electronic lock with adjustable dead latch channel location, especially the one that can adjust dead latch channel location directly at the plate of the electronic lock.

### 2. Description of the Related Art

The electronic lock is used as the access control system. The difference from the genera lock is that the electronic lock cannot be used alone and must be operated with a mechanical lock box (such as a deadbolt lock, etc.). Install the electronic lock on the door frame and electronically control the lock, so that the mechanical lock box can be directly pushed or pulled open without being used; therefore, the access control system uses the electronic lock, which can be accessed electronically or directly with the key to open the mechanical lock box to achieve the convenience of electric control and manual use.

U.S. Pat. No. 8,157,302B1 discloses an electronic lock. The longitudinal length of the housing cavity is usually much larger than that of the latch bolt for making the housing cavity easy to align the latch bolt of the mechanical lock box while installing the electronic lock on the door frame, and the latch bolt of the mechanical lock box is also equipped with a dead latch, so the design of the electronic lock must also consider whether the dead latch can be ejected smoothly when the door is opened. This patent let the ramp element that guide the latch bolt exits the electronic lock has a channel, and the channel on the ramp element is adjusted to align with the dead latch, and then the screw is used to position the ramp element; however, this patent must disassemble the entire electronic lock from the door frame and the locking screw of the electric lock body must be loosened in order to adjust the position of the dead latch channel, which is very inconvenient. Loosening the locking screw of the electric lock body is risky, the electronic lock may malfunction due to human error during the process.

### SUMMARY OF THE INVENTION

It is a primary objective of the present invention to solve the problem that the electric lock must be uninstalled from the door frame and the screw must be loosen in order to adjust the position of the dead latch channel, and having the effect that doesn't need to uninstall the electric lock and the screw, and can adjust the dead latch channel location directly at the plate of the electronic lock.

In order to achieve the above objectives, the present invention comprise: an electronic lock body, having a housing cavity and a latch bolt; a plate, combined to the electronic lock body, and beside covering the electronic lock body, the plate extended upward and downward to the opening side of the plate, further having a gap for exposing the housing cavity and the latch bolt; a fixed adjust element, two ends of the fixed adjust element are combined to the bottom surface of the plate, the middle section of the fixed adjust element is arranged below the gap, and set a fixed channel and a fixed positioning unit; and an active adjust element, sleeved on the middle section of the fixed adjust element and corresponding to the latch bolt set a ramp element, arranged between the bottom surface of the plate and the middle section of the fixed adjust element, the ramp element having an active channel relative to the positioning channel, and relative to the fixed positioning unit having an active positioning unit, the width of the active channel is narrower than the width of the fixed channel.

Moreover, the middle section of the fixed adjust element is a trapezoidal rod, the surface of the trapezoidal rod which toward the latch bolt is bevel, and the fixed positioning unit is arranged at the top surface of the trapezoidal rod. The active adjust element having a sleeve slot relative to the trapezoidal rod, the active positioning unit is arranged at the top edge of the sleeve slot, the ramp element having a ramp section toward latch bolt and a cross section extended from the top end of the ramp section to the opening side, and the tail end of the cross section is overlapped to the side edge of the opening side of the gap. The fixed positioning unit is a pinion or a rack, and the active positioning units relative to the fixed positioning unit is a pinion or a rack. The plate using plate screws to combine to the electronic lock body, the two ends of the fixed adjust element are using adjust screw to combine to the bottom surface of the plate.

Whereby after installing the plate on the door frame so that the housing cavity is aligned with the latch bolt of the mechanical lock box, if the active channel is not aligned with the dead latch of the mechanical lock box, then loosen the adjusting screw to let the rack of the active adjust element and the pinion of the fixed adjust element be out of the occlusal state, and then move the active adjust element to let the active channel be aligned with the dead latch of the mechanical lock box, and then tighten the adjust screw to make the rack of the active adjust element and the pinion of the fixed adjustment element return to occlusion state.

### BRIEF DESCRIPTION OF THE DRAWINGS

FIG. 1 is an exploded perspective views of the present invention structure;

FIG. 2 is an assembly perspective views of the present invention structure;

FIG. 3 is a top views of the present invention structure;

FIG. 4A is a sectional view along line 4A-4A in FIG. 3 (showing the occlusion state of the rack and the pinion);

FIG. 4B is a zoom in view of the circled part in FIG. 4A;

FIG. 5A is a sectional view showing the occlusion state of the rack and the pinion in FIG. 4A;

FIG. 5B is a zoom in view of the circled part in FIG. 5A;

FIG. 6 is a top views of the present invention (when the active channel is at the highest point);

FIG. 7 is a top views of the present invention n (when the active channel is at the lowest point).

### DETAILED DESCRIPTION OF THE PREFERRED EMBODIMENT

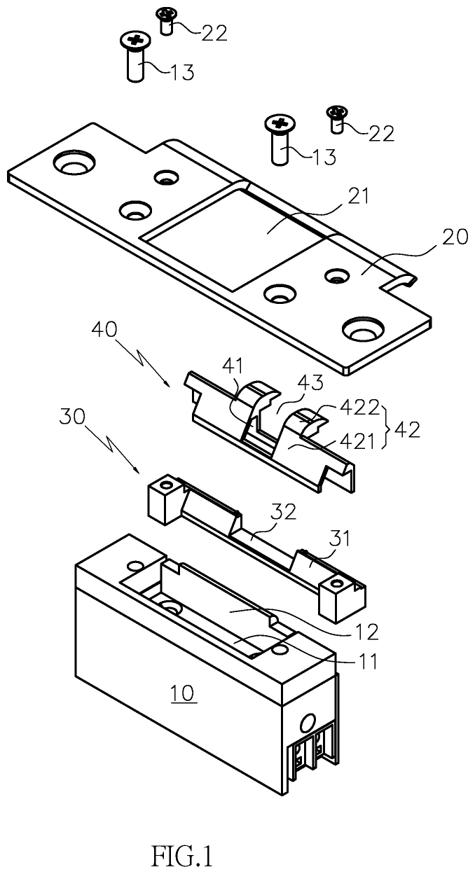

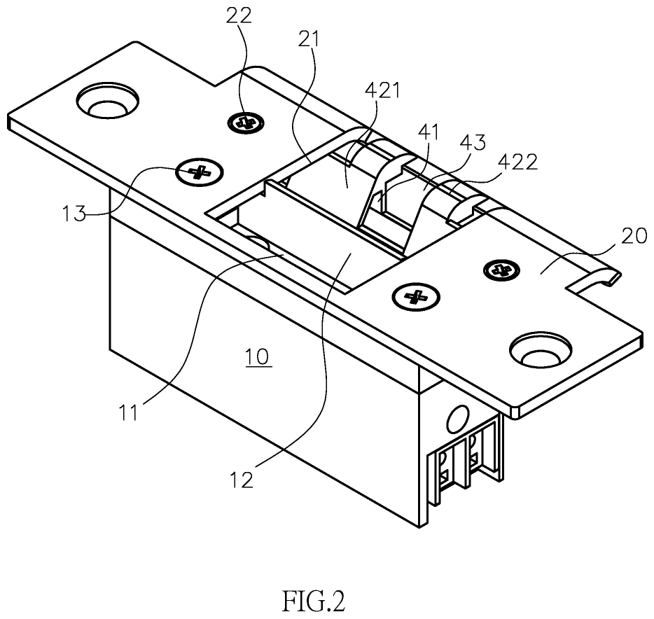

Referring to FIGS. 1-5B, the electronic lock with adjustable dead latch channel location, including: an electronic lock body 10, having a housing cavity 11 and a latch bolt 12; a plate 20, using plate screws 13 to combine to the electronic lock body 10, and beside covering the electronic lock body 10, the plate extended upward and downward to the opening side of the plate 20, further having a gap 21 for exposing the housing cavity 11 and the latch bolt 12; a fixed adjust element 30, two ends of the fixed adjust element 30 are using adjust screw 22 to combined to the bottom surface of the plate 20, the middle section of the fixed adjust element 30 is arranged below the trapezoidal rod 31 of the gap 21, and set a fixed channel 32 and a fixed positioning unit (it can be the pinion 33 in the drawing), and the surface of the trapezoidal rod 31 which toward the latch bolt 12 is bevel, and the pinion 33 is arranged at the top surface of the trapezoidal rod 31; and an active adjust element 40, having a sleeve slot 41 relative to the trapezoidal rod 31, and corresponding to the latch bolt 12 set a ramp element 42, the active adjust element 40 sleeved on the middle section of the fixed adjust element 30, arranged between the bottom surface of the plate 20 and the middle section of the fixed adjust element 30; the ramp element 42 having an active channel 43 relative to the positioning channel 32, the top edge of the sleeve slot 41 relative to the pinion 33 having an active positioning unit (it can be the rack 44 in the drawing), the width of the active channel 43 is narrower than the width of the fixed channel 32; the ramp element 42 having a ramp section 421 toward latch bolt 12 and a cross section 422 extended from the top end of the ramp section 421 to the opening side, and the tail end of the cross section 422 is overlapped to the side edge of the opening side of the gap 21.

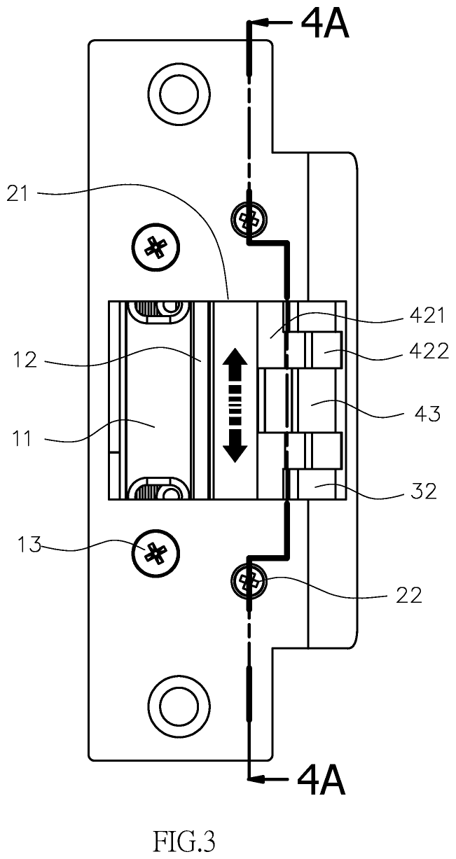

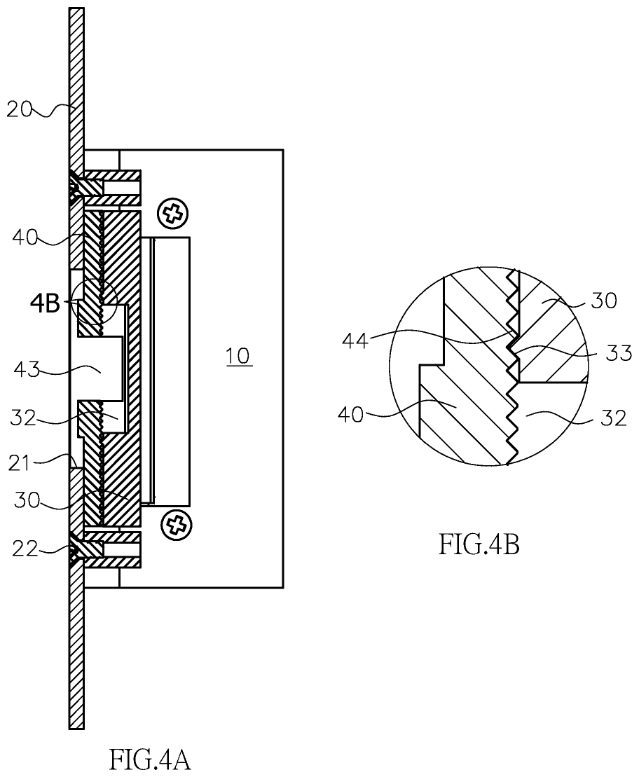

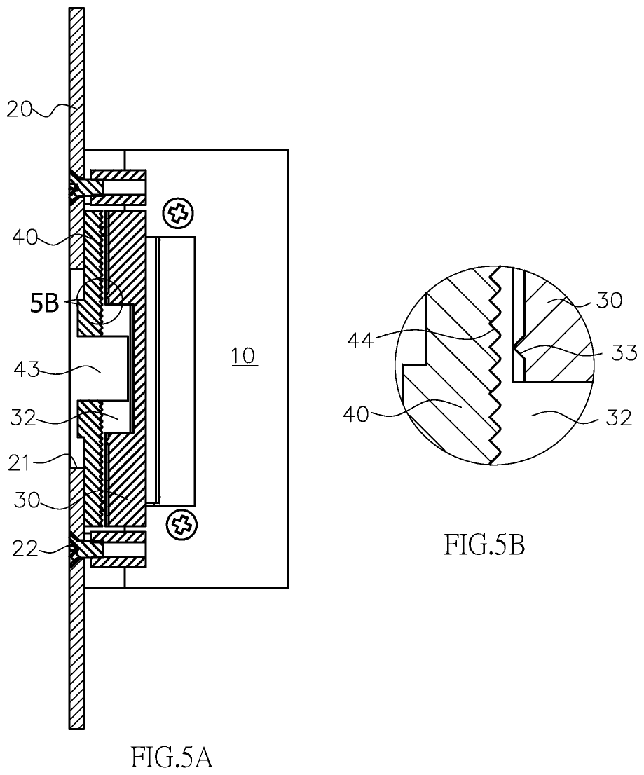

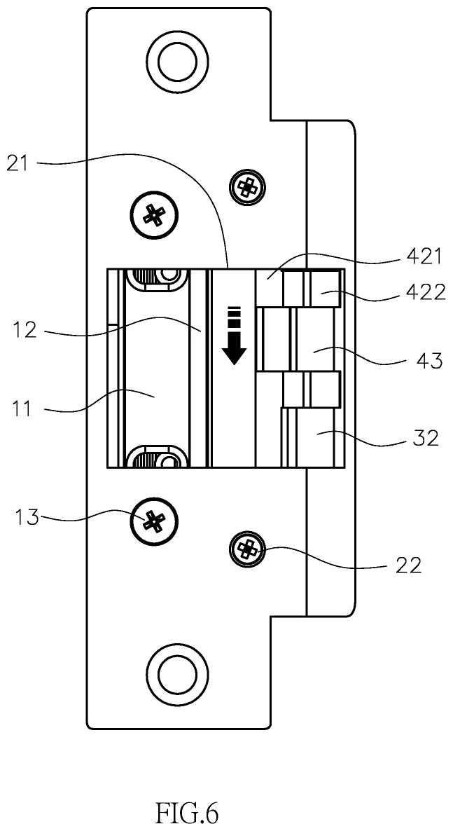

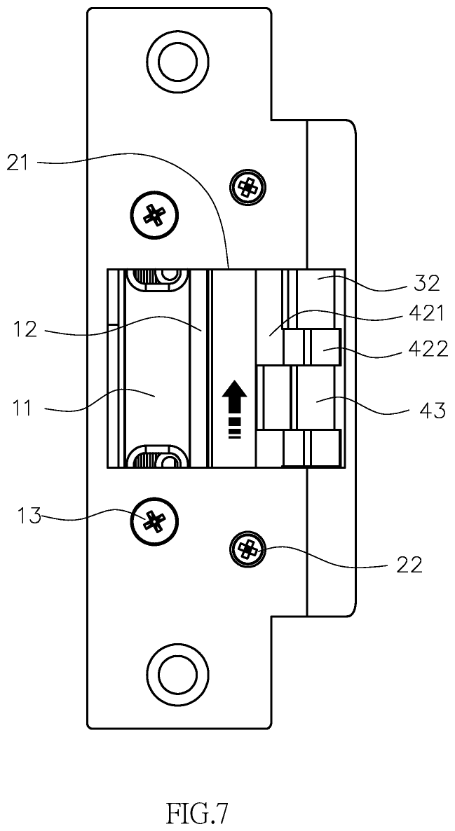

With the feature disclosed above after installing the plate 20 on the door frame so that the housing cavity 11 is aligned with the latch bolt of the mechanical lock box, if the active channel 43 is not aligned with the dead latch of the mechanical lock box, then loosen the adjusting screw 22 to let the rack 44 of the active adjust element 40 and the pinion 33 of the fixed adjust element 30 be out of the occlusal state, as FIGS. 5A and 5B showing, and then as FIGS. 3, 6 and 7 showing, move the active adjust element 40 to let the active channel 43 be aligned with the dead latch of the mechanical lock box, and then tighten the adjust screw 22 to make the rack 44 of the active adjust element 40 and the pinion 33 of the fixed adjustment element 30 return to occlusion state, as FIGS. 4A and 4B showing, so the procedure for adjusting the position of the active channel 43 is completed; Therefore, since the occlusal state between the rack 44 and the pinion 33 is very stable, the active channel 43 located in the active adjust element 40 will not have the problem of offset, and the position of the active channel 43 can be directly adjusted by loosening the adjust screw 22 from the plate 20, so the present invention does not need to disassemble the entire electronic lock from the door frame, and can directly adjust the position of the dead latch channel from the electronic lock plate under the condition that the main structure of the electronic lock is not removed at all to avoid the malfunction of the electronic lock.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electronic lock with adjustable dead latch channel location, comprising:
an electronic lock body, having a housing cavity and a latch bolt;
a plate, combined to the electronic lock body, and beside covering the electronic lock body, the plate extended upward and downward to the opening side of the plate, further having a gap for exposing the housing cavity and the latch bolt;
a fixed adjust element, two ends of the fixed adjust element are combined to the bottom surface of the plate, the middle section of the fixed adjust element is arranged below the gap, and set a fixed channel and a fixed positioning unit; and
an active adjust element, sleeved on the middle section of the fixed adjust element and corresponding to the latch bolt set a ramp element, arranged between the bottom surface of the plate and the middle section of the fixed adjust element, the ramp element having an active channel relative to the positioning channel, and relative to the fixed positioning unit having an active positioning unit, the width of the active channel is narrower than the width of the fixed channel.

2. The electronic lock with adjustable dead latch channel location as claimed in claim 1, wherein the middle section of the fixed adjust element is a trapezoidal rod, the surface of the trapezoidal rod which toward the latch bolt is bevel, and the fixed positioning unit is arranged at the top surface of the trapezoidal rod.

3. The electronic lock with adjustable dead latch channel location as claimed in claim 2, wherein the active adjust element having a sleeve slot relative to the trapezoidal rod, the active positioning unit is arranged at the top edge of the sleeve slot, the ramp element having a ramp section toward latch bolt and a cross section extended from the top end of the ramp section to the opening side, and the tail end of the cross section is overlapped to the side edge of the opening side of the gap.

4. The electronic lock with adjustable dead latch channel location as claimed in claim 3, wherein the fixed positioning unit is a pinion or a rack, and the active positioning units relative to the fixed positioning unit is a pinion or a rack.

5. The electronic lock with adjustable dead latch channel location as claimed in claim 4, wherein the plate using plate screws to combine to the electronic lock body, the two ends of the fixed adjust element are using adjust screw to combine to the bottom surface of the plate.
